(19) United States
(12) Patent Application Publication
(10) Pub. No.: US 2010/0246592 A1
(43) Pub. Date: Sep. 30, 2010

(54) LOAD BALANCING METHOD FOR NETWORK INTRUSION DETECTION

(75) Inventors: Xiao-Qian Li, Tianjin (CN); Tom Chen, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei (TW)

(21) Appl. No.: 12/414,784

(22) Filed: Mar. 31, 2009

(51) Int. Cl. H04L 12/56; G06F 21/00

(52) U.S. Cl. 370/412; 726/23

(57) ABSTRACT

A load balancing method for network intrusion detection includes the following steps. Packets are received from a client. The data packets include a protocol type and a protocol property. An intrusion detection procedure is loaded on a receiving end. A corresponding request queue is set for each intrusion detection procedure. The request queue is used for storing the data packets. The data packets are processed a separation procedure, and are categorized into data packets of a chain type and data packets of a non-chain type according to the protocol type. The data packets of the chain type are processed by a first distribution procedure. The data packets of the non-chain type are processed by a second distribution procedure. The distribution procedures distribute the data packets to the corresponding request queues according to the protocol property. The corresponding intrusion detection procedure is performed on the data packets in each request queue.

### BACKGROUND OF THE INVENTION

1. Field of Invention

The present invention relates to a technical field of network security, and more particularly to a load balancing method for network intrusion detection.

2. Related Art

Intrusion detection is to perceive an intrusion. To perform the intrusion detection, information is collected at several key points in a computer network or a computer system and analyzed, so as to find whether behaviors violating security policies and signs of being attacked exist in the network or system. An intrusion detection system (IDS) is a combination of software and hardware for intrusion detection. Generally speaking, the IDS may be categorized as a host type and a network type. A host intrusion detection system usually uses system logs, application logs and the like as a data source. A network intrusion detection system (NIDS) uses data packets on a network as a data source.

The network intrusion detection system is usually disposed within relatively important network segments or on a network edge, so as to monitor various data packets in the network. A processing speed of a network security device is always a big bottleneck influencing network performance. Although a network intrusion detection system is usually connected to the network in parallel, if the detection speed may not keep pace with a transmission speed of network data, the network intrusion detection system will miss a part of data packets, causing missing report and influencing correctness and effectiveness of the system. The network intrusion detection system captures every data packet in the network, and needs to spend a lot of time and system resources for analyzing and matching whether the data packet has features of some type of attack. Thus, how to improve the throughput processing capacity of a network intrusion detection system becomes a critical problem for the application of the system in the developing network environment.

A multi-thread load balancing method for intrusion detection is disclosed in China Patent Application Publication No. CN1561032A. A distribution method using an application protocol as a standard is used to realize load balancing. As shown in FIG. 1, a packet capture engine puts data packets of different protocol types into different processing queues according to a processing policy of load balancing. Then, a multi-thread intrusion detection system is used to process the data packets respectively.

As shown in FIG. 1, the patent application distributes application protocols such as HTTP, TELNET, and FTP to different threads for processing, so as to achieve load balancing. However, such a load balancing algorithm is incapable of achieving a satisfactory effect in an actual network environment.

In the actual network environment, percentages of traffics in various application protocols are unbalanced. Ellacoya Networks, a provider of network service control system solutions, discovered that the HTTP makes up about 46% of all the network traffics by analyzing one million broadband users in North America. The P2P (most of them are various UDP application traffics) ranks the second, making up 37% of all the network traffics. Additionally, the newsgroup makes up a percentage of 9%, the non-HTTP video stream makes up a percentage of 3%, the online gaming makes up a percentage of 2%, and the VoIP makes up a percentage of 1%.

Thus, if the division is made according to application protocols, the threads processing the HTTP protocol must process 46% of all the traffics, and the threads processing various P2P protocols process 37% in total. Similarly, the threads processing the online gaming only process 2%, and the threads processing other protocols such as the TELNET process even less. Such a load balancing manner is apparently undesirable.

### SUMMARY OF THE INVENTION

To solve the problems and defects in the prior art, one of the objectives of the present invention is to provide a load balancing method for network intrusion detection. The method comprises the following steps: receiving a plurality of data packets from a client, wherein the data packets at least comprise a protocol type and a protocol property; loading at least an intrusion detection procedure on a receiving end; setting a corresponding request queue for each of the intrusion detection procedures, wherein the request queue is used to store the data packets; processing the data packets by a separation procedure, wherein the separation procedure categorizes the data packets into data packets of a chain type and data packets of a non-chain type according to the protocol type; processing the data packets of the chain type to a first distribution procedure, wherein the first distribution procedure distributes the data packets to the corresponding request queue according to the protocol property; processing the data packets of the non-chain type to a second distribution procedure, wherein the second distribution procedure distributes the data packets to the corresponding request queue according to the protocol property; and performing the corresponding intrusion detection procedure on the data packets in each of the request queues.

To sum up, compared with the prior art, the present invention may provide a sufficient discrete degree for load balancing, so as to make full use of the multi-process/multi-thread capacity, such that system resources may be used more effectively for intrusion detection processing.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a multi-thread load balancing method for intrusion detection in the prior art;

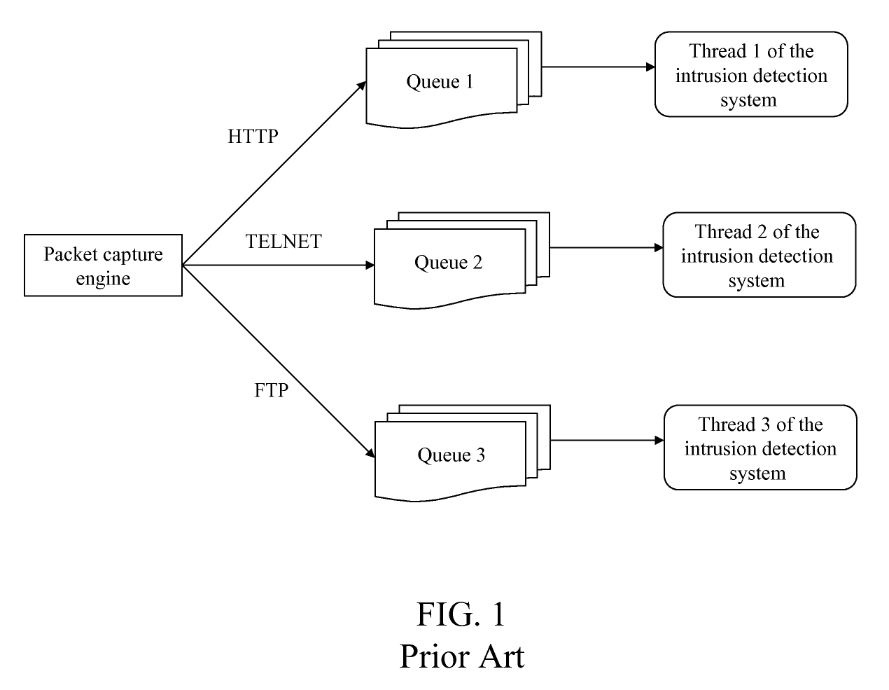

FIG. 2 is a schematic view of the architecture for network intrusion detection of the present invention;

FIG. 3 is a flow chart of steps of a load balancing method for network intrusion detection of the present invention;

FIG. 4 is a schematic view of detailed operating steps of a separation procedure in Step S340;

FIG. 5 is a schematic view of an operating process of a first distribution procedure;

FIG. 6 is a schematic view of an operating process of a second distribution procedure; and

FIG. 7 is a schematic view of the architecture for request queue distribution of the present invention.

### DETAILED DESCRIPTION OF THE INVENTION

The present invention still employs a multi-process/multi-thread architecture to process data packet queues. However, the present invention may provide a sufficient discrete degree for load balancing, so as to make full use of the multi-process/multi-thread capacity, such that system resources may be used more effectively for intrusion detection processing.

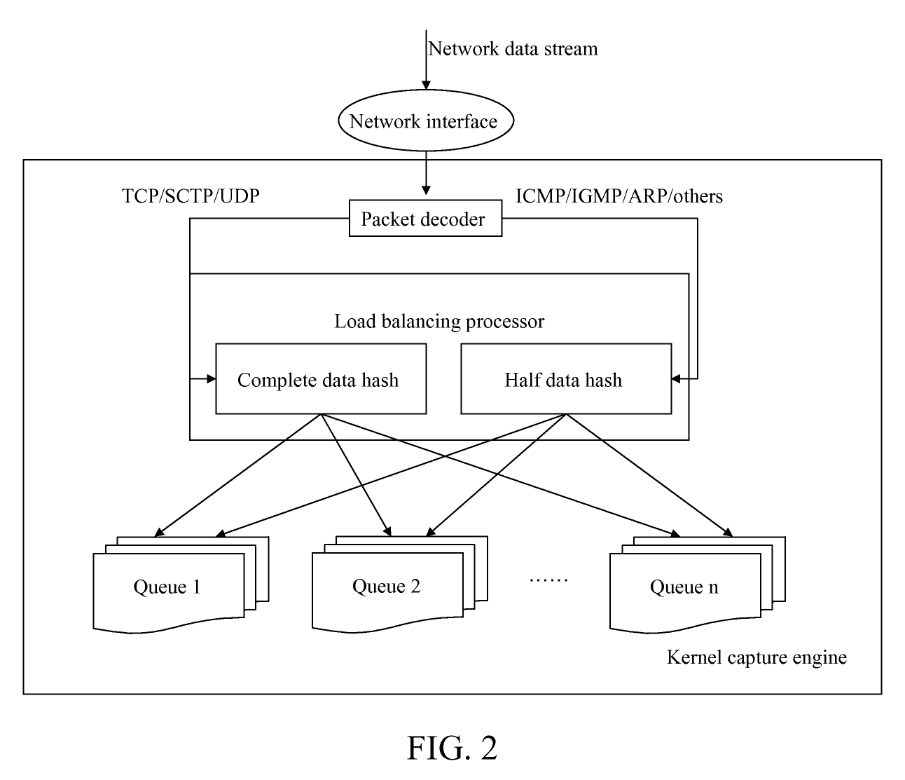

FIG. 2 is a schematic view of the architecture for network intrusion detection of the present invention. As shown in FIG. 2, a load balancing policy of the present invention does not depend on only the advanced protocol type of the data packets. Instead, the corresponding data (tuples) is extracted, and the data of a single data packet may be marked by the tuples to perform the separation.

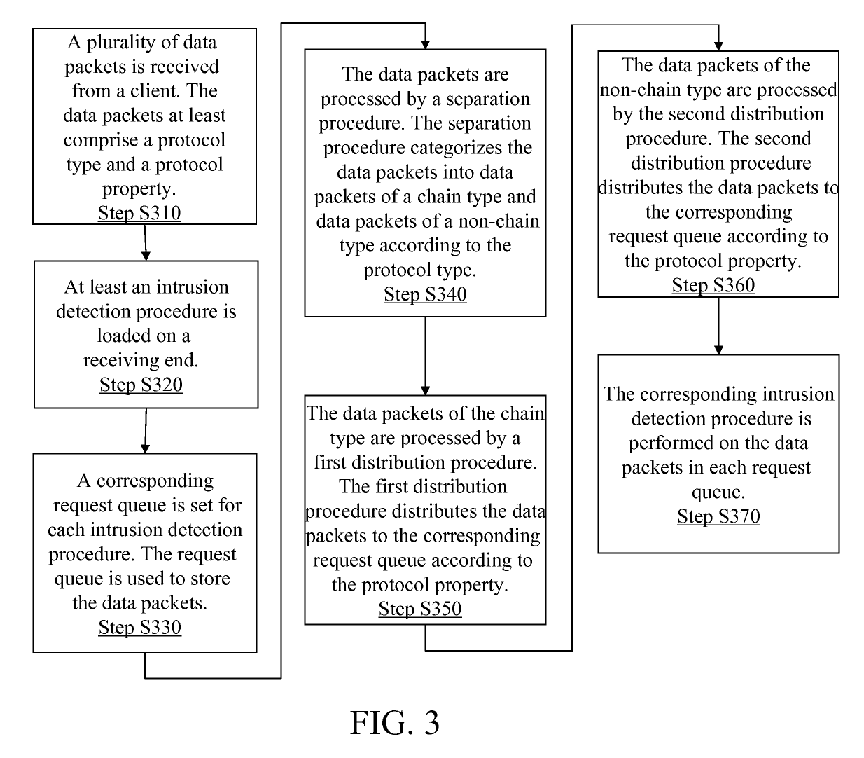

Referring to FIG. 3 together, a load balancing policy of the present invention is as follows.

Step S310: a plurality of data packets is received from a client. The data packet at least includes a protocol type and a protocol property;

Step S320: at least an intrusion detection procedure is loaded on a receiving end;

Step S330: a corresponding request queue is set for each intrusion detection procedure, and the request queue is used to store the data packets;

Step S340: the data packets are processed by a separation procedure, and are categorized into data packets of a chain type and data packets of a non-chain type according to the protocol type;

Step S350: the data packets of the chain type are processed by a first distribution procedure. The first distribution procedure distributes the data packets to the corresponding request queue according to the protocol property;

Step S360: the data packets of the non-chain type are processed by the second distribution procedure. The second distribution procedure distributes the data packets to the corresponding request queue according to the protocol property; and

Step S370: the corresponding intrusion detection procedure is performed on data packets in each request queue.

The protocol types of the data packets comprise a Transmission Control Protocol (TCP), a Stream Transmission Control Protocol (STCP), a User Datagram Protocol (UDP), an Internet Control Message Protocol (ICMP), an Internet Group Management Protocol (IGMP), and an Address Resolution Protocol (ARP). The protocol properties of the data packets comprise a source IP, a source port, a destination IP, and a destination port.

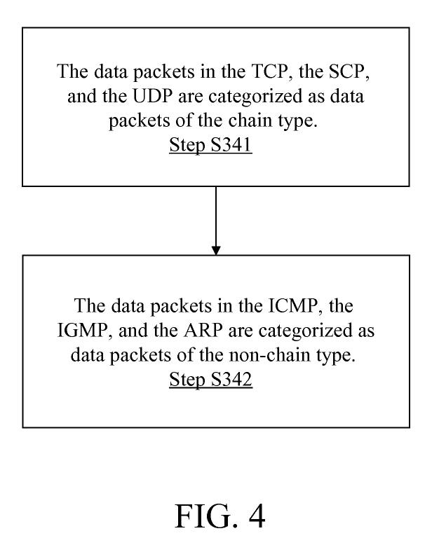

Referring to FIG. 4, detailed operating steps of the separation procedure in Step S340 are shown.

Step S341: the data packets in the TCP, the SCP, and the UDP are categorized as data packets of the chain type; and

Step S342: the data packets in the ICMP, the IGMP, and the ARP are classified as data packets of the non-chain type.

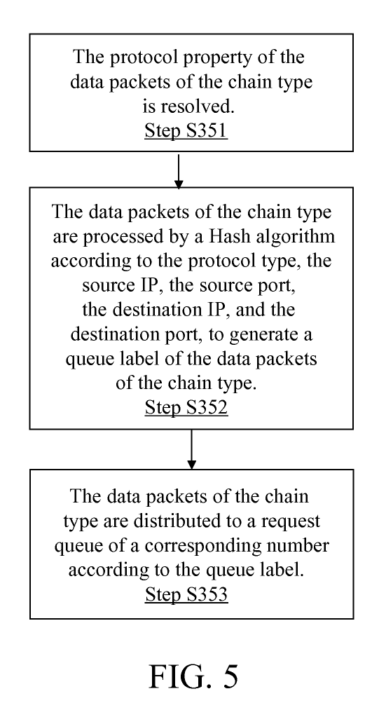

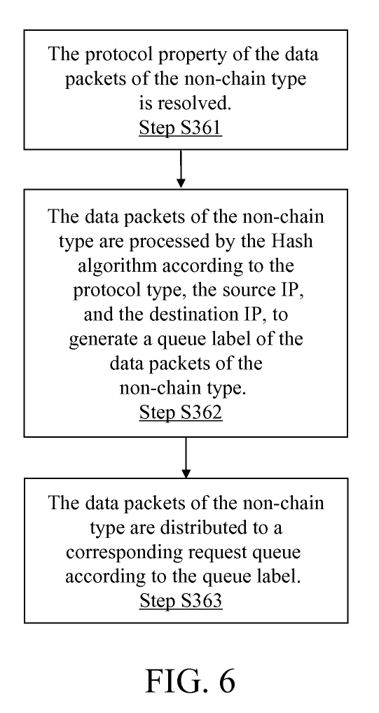

After the receiving end completes the separation procedure of the data packets, the receiving end performs the first distribution procedure on the data packets of the chain type, and performs the second distribution procedure on the data packets of the non-chain type, respectively. To illustrate the first distribution procedure and the second distribution procedure clearly, refer to FIGS. 5 and 6 together, which are schematic views of operating processes of the first distribution procedure and the second distribution procedure, respectively. The first distribution procedure includes the following steps.

Step S351: the protocol property of the data packets of the chain type is resolved;

Step S352: the data packets of the chain type are processed by a Hash algorithm according to the protocol type, the source IP, the source port, the destination IP, and the destination port, to generate a queue label of the data packets of the chain type; and

Step S353: the data packets of the chain type are distributed to a request queue of a corresponding number according to the queue label.

In addition, the second distribution procedure includes the following steps.

Step S361: the protocol property of the data packets of the non-chain type is resolved;

Step S362: the data packets of the non-chain type are processed by the Hash algorithm according to the protocol type, the source IP, and the destination IP, to generate a queue label of the data packets of the non-chain type; and

Step S363: the data packets of the non-chain type are distributed to a corresponding request queue according to the queue label.

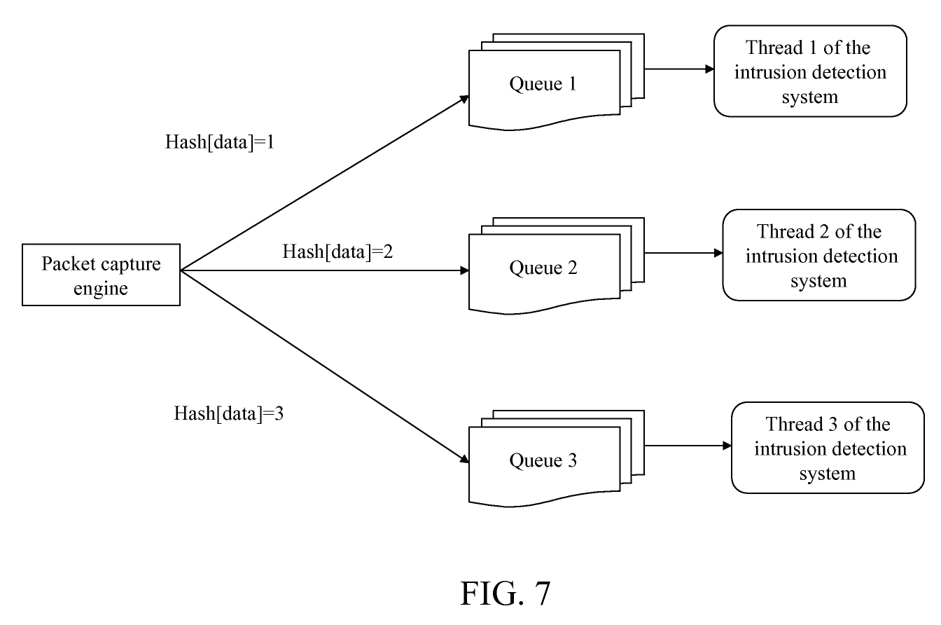

Finally, the numbered data packets are sent to the request queues with the corresponding numbers, and are processed correspondingly by the intrusion detection procedure that each request queue is connected to. FIG. 7 is a schematic view of the architecture for request queue distribution of the present invention.

To illustrate the operating process of the present invention more clearly, the following example is used to illustrate detailed implementation aspects of the present invention.

### DETAILED IMPLEMENTATION EXAMPLE

First, a same number of request queues are created according to the number of the processing processes provided by a network intrusion detection system. Here, it is assumed that the number of the request queues is Q_NUM, and the number of the request queues is 4, then Q_NUM=4. The four request queues are assigned with numbers Q1, Q2, Q3, and Q4.

It is assumed that two different data packets are received. The two data packets are Packet A and Packet B.

A structure of Packet A is as shown in the following.

| | | | |
|---|---|---|---|
| MAC | IP | TCP | Data . . . |
| header | header | header | |

A structure of Packet B is as shown in the following.

| | | | |
|---|---|---|---|
| MAC | IP | ICMP | Data . . . |
| header | header | header | |

For Packet A, the following information is captured from the IP header.

Protocol=0x06(TCP)

Srcip=0x 0ABE3C3D(10.190.60.61)

Dstip=0x DA1E6CB8(218.30.108.184)

The following information is obtained from the TCP header.

Srcport=0x 0CA3(3235)

Dstport=0x 0050(80)

For Packet B, the following information is obtained from the IP header.

Protocol=0x01(ICMP)

Srcip=0x 0ABE3CD1(10.190.60.209)

Dstip=0x 0ABE3C3E(10.190.60.62)

First, Packet A and Packet B are processed by the separation procedure. For Packet A, as Protocol=0x06(TCP), Packet A is a data packet of a chain type. For Packet B, as Protocol=0x01(ICMP), the Packet B is a data packet of a non-chain type. Next, the receiving end processes Packet A with the first distribution procedure. In addition, the receiving end processes Packet B with the second distribution procedure.

Packet A is processed by the first distribution procedure as follows:

u_int Fulltuplehash(Protocol, Srcip, Dstip, Srcport, Dstport)
{
u_16bit pro = Protocol&0x00FF;
u_16bit sip_h = (Srcip>>16)&0Xffff
u_16bit sip_l = (Srcip)&0Xffff
u_16bit dip_h = (Dstip>>16)&0Xffff
u_16bit dip_l = (Dstip)&0Xffff
u_16bit hash = pro;
hash\hat{ }=(hash<<3)|(hash>>13)|sip_h;
hash\hat{ }=(hash<<3)|(hash>>13)|sip_l;
hash\hat{ }=(hash<<3)|(hash>>13)|dip_h;
hash\hat{ }=(hash<<3)|(hash>>13)|dip_l;
hash\hat{ }=(hash<<3)|(hash>>13)|Srcport;
hash\hat{ }=(hash<<3)|(hash>>13)|Dstport;
hash_id = hash%Q_NUM
return hash_id+1;
}
Q_ID_A = Fulltuplehash(Protocol, Srcip, Dstip, Srcport, Dstport) = 3

Packet B is processed by the second distribution procedure as follows:

u_int Halftuplehash(Protocol, Srcip, Dstip)
{
u_16bit pro = Protocol&0x00FF;
u_16bit sip_h = (Srcip>>16)&0Xffff
u_16bit sip_l = (Srcip)&0Xffff
u_16bit dip_h = (Dstip>>16)&0Xffff
u_16bit dip_l = (Dstip)&0Xffff
u_16bit hash = pro;
hash\hat{ }=(hash<<3)|(hash>>13)|sip_h;
hash\hat{ }=(hash<<3)|(hash>>13)|sip_l;
hash\hat{ }=(hash<<3)|(hash>>13)|dip_h;
hash\hat{ }=(hash<<3)|(hash>>13)|dip_l;
hash_id = hash%Q_NUM
return hash_id+1;
}
Q_ID_B = Halftuplehash(Protocol, Srcip, Dstip) = 4

As Q_ID_A=3, Packet A is stored in the request queue Q3, so as to be processed by the corresponding processing process of the network intrusion detection system. As Q_ID_B=4, Packet B is stored in the request queue Q4, so as to be processed by the corresponding processing process of the network intrusion detection system.

What is claimed is:

1. A load balancing method for network intrusion detection, wherein a receiving end performs load processing on received data packets, the method comprising:
receiving a plurality of data packets from a client, wherein the data packets at least comprise a protocol type and a protocol property;
loading at least an intrusion detection procedure on the receiving end;
setting a corresponding request queue for each of the intrusion detection procedures, wherein the request queue is used to store the data packets;
processing the data packets by a separation procedure, wherein the separation procedure categorizes the data packets into data packets of a chain type and data packets of a non-chain type according to the protocol type;
processing the data packets of the chain type to a first distribution procedure, wherein the first distribution procedure distributes the data packets to the corresponding request queue according to the protocol property;
processing the data packets of the non-chain type to a second distribution procedure, wherein the second distribution procedure distributes the data packets to the corresponding request queue according to the protocol property; and
performing the corresponding intrusion detection procedure on the data packets in each of the request queues.

2. The method according to claim 1, wherein the protocol type comprises a Transmission Control Protocol (TCP), a Stream Transmission Control Protocol (STCP), a User Datagram Protocol (UDP), an Internet Control Message Protocol (ICMP), an Internet Group Management Protocol (IGMP), or an Address Resolution Protocol (ARP).

3. The method according to claim 2, wherein the separation procedure further comprises:
categorizing the data packets in the TCP, the SCTP, and the UDP as the data packets of the chain type; and
categorizing the data packets in the ICMP, the IGMP, and the ARP as the data packets of the non-chain type.

4. The method according to claim 1, wherein the protocol property comprises a source IP, a source port, a destination IP, or a destination port.

5. The method according to claim 4, wherein the first distribution procedure further comprises:
resolving the protocol property of the data packets of the chain type;
processing the data packets of the chain type by a Hash algorithm according to the protocol type, the source IP, the source port, the destination IP, and the destination port to generate a queue label of the data packets of the chain type; and
distributing the data packets of the chain type to the request queue of a corresponding number according to the queue label.

6. The method according to claim 4, wherein the second distribution procedure further comprises:
resolving the protocol property of the data packet of the non-chain type;
processing the data packets of the non-chain type by a Hash algorithm according to the protocol type, the source IP, and the destination IP to generate a queue label of the data packets of the non-chain type; and
distributing the data packets of the non-chain type to the corresponding request queue according to the queue label.
